(19) United States
(12) Patent Application Publication
(10) Pub. No.: US 2020/0332419 A1
(43) Pub. Date: Oct. 22, 2020

(54) Surface Treatment Agent, Method for Producing Aluminum Alloy Material for Cans, Said Aluminum Alloy Material Having Surface-Treated Coating Film, and Aluminum Alloy Can Body and Can Lid Using Same

(71) Applicants: Nihon Parkerizing Co., Ltd., Tokyo (JP); Toyo Seikan Co., Ltd., Tokyo (JP)

(72) Inventors: Akio Shimizu, Tokyo (JP); Akinobu Tsuneishi, Tokyo (JP); Shoichi Naruse, Tokyo (JP); Ryohei Kikuchi, Tokyo (JP); Wataru Kurokawa, Kanagawa (JP); Yuuji Funagi, Kanagawa (JP); Noriyoshi Obara, Kanagawa (JP); Shuji Nakano, Kanagawa (JP)

(21) Appl. No.: 16/754,173

(22) PCT Filed: Oct. 11, 2018
(86) PCT No.: PCT/JP2018/037951

§ 371 Date: Apr. 7, 2020

(30) Foreign Application Priority Data
Oct. 12, 2017 (JP) 2017-198237

(51) Int. Cl. C23C 22/34; C23C 28/00; B05D 1/02; B05D 7/14

(52) U.S. Cl. CPC C23C 22/34; C23C 28/00; B05D 2202/25; B05D 7/14; B05D 2508/00; B05D 1/02

(57) ABSTRACT

The object of the present invention is achieved by a surface treatment agent to be used for surface treatment of an aluminum alloy material for forming cans, which includes zirconium, aluminum, a nitrate radical, and fluorine, wherein
the pH ranges from 2.0 to 4.0,
the molar mass concentration of the zirconium ranges from 3.2 mmol/kg to 33.0 mmol/kg,
the molar mass concentration of the aluminum ranges from 14.8 mmol/kg to 74.1 mmol/kg,
the molar mass concentration of the nitrate radical ranges from 16.1 mmol/kg to 161.4 mmol/kg,
the molar mass concentration of the fluorine ranges from 52.6 mmol/kg to 526.3 mmol/kg,
(F−6Zr)/Al≥2.5 is satisfied (wherein, F represents the molar mass concentration of the fluorine, Zr represents the molar mass concentration of the zirconium, and Al represents the molar mass concentration of the aluminum, and
substantially no phosphorus compound is contained.

### TECHNICAL FIELD

The present invention relates to a surface treatment agent to be used for surface treatment of an aluminum alloy material for forming cans, a method for producing an aluminum alloy material for forming cans having a surface-treated coating, and an aluminum alloy can body and an aluminum alloy can lid using the same.

### BACKGROUND ART

A phosphoric acid chromate-based surface treatment agent has been widely used as a surface treatment agent for aluminum alloy materials. However, since such an agent contains harmful hexavalent chromium, a chromium-free surface treatment agent containing no hexavalent chromium because of such an environmental problem, and capable of imparting high corrosion resistance and adhesiveness equivalent to a phosphoric acid chromate-based surface treatment is required.

Patent Document 1 proposes a surface-treated metal material having an inorganic surface-treated layer containing Zr, O, and F as main components but containing no phosphate ion.

### CITATION LIST

### Patent Document

Patent Document 1: Japanese Unexamined Patent Publication No. 2005-97712

### SUMMARY OF INVENTION

### Technical Problem

An object of the present invention is to provide a surface treatment agent, which is capable of forming a surface-treated coating having excellent corrosion resistance and adhesiveness on/over the surface of an aluminum alloy material for forming cans. Another object of the present invention is to provide an aluminum alloy material for forming cans having a surface-treated coating obtained through surface treatment using the surface treatment agent, and a can body and a can lid made of the alloy material.

### Solution to Problem

The surface treatment agent of the present invention comprises zirconium, aluminum, a nitrate radical, and fluorine in specific amounts, and, is capable of forming a surface-treated coating having excellent corrosion resistance and adhesiveness since the amount of aluminum and the amount of fluorine satisfy a specific relational expression. The present invention includes the following [1] to [7].

[1] A surface treatment agent to be used for surface treatment of an aluminum alloy material for forming cans, comprising zirconium, aluminum, nitrate radical, and fluorine, wherein
a pH ranges from 2.0 to 4.0,
a molar mass concentration of the zirconium ranges from 3.2 mmol/kg to 33.0 mmol/kg, or may range from 3.2 mmol/kg to 11.0 mmol/kg,
a molar mass concentration of the aluminum ranges from 14.8 mmol/kg to 74.1 mmol/kg,
a molar mass concentration of the nitrate radical ranges from 16.1 mmol/kg to 161.4 mmol/kg, or may range from 16.1 mmol/kg to 80.7 mmol/kg,
a molar mass concentration of the fluorine ranges from 52.6 mmol/kg to 526.3 mmol/kg, and
(F−6Zr)/Al≥2.5 is satisfied, and substantially no phosphorus compound is contained,
   wherein, F represents the molar mass concentration of the fluorine, Zr represents the molar mass concentration of the zirconium, and Al represents the molar mass concentration of the aluminum.

[2] A method for producing an aluminum alloy material for forming cans having a surface-treated coating, comprising a step of contacting the surface treatment agent according to [1] on/over the surface of an aluminum alloy material for forming cans.

[3] A method for producing an aluminum alloy material for forming cans having a multilayer coating comprising a surface-treated coating and a base coating, comprising:
a step of contacting the surface treatment agent according to [1] on/over the surface of the aluminum alloy material for forming cans; and
a step of contacting a base treatment agent comprising a polymer having a repeating structure represented by the following formula (I):

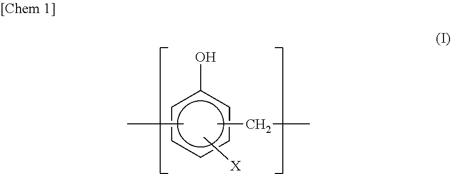

Wherein, in formula (I), X is a hydrogen atom or a Z group represented by the following formula (II):

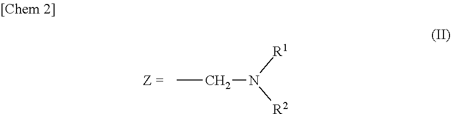

Wherein, in formula (II), R¹ and R² are each independently an alkyl group having 10 or less carbon atoms or a hydroxyl alkyl group having 10 or less carbon atoms, and the introduction rate of the Z group ranges from 0.3 to 1.0 per benzene ring,
over the surface of the aluminum alloy material for forming cans with which the surface treatment agent is contacted, wherein
the weight average molecular weight of the polymer ranges from 1,000 to 100,000, when all Xs in the formula (I) are hydrogen atoms.

[4] An aluminum alloy material for forming cans having a surface-treated coating, which is obtained by the production method according to [2], wherein the adhesion amount of the surface-treated coating ranges from 1 to 50 mg/m² in terms of the mass of a zirconium atom per unit area.

[5] An aluminum alloy material for forming cans having a multilayer coating comprising a surface-treated coating and a base coating, obtained by the production method according to [3], wherein the adhesion amount of the surface-treated coating ranges from 1 to 50 mg/m² in terms of the mass of a zirconium atom per unit area, and
the adhesion amount of the base coating ranges from 0.1 to 30 mg/m² in terms of the mass of carbon per unit area.

[6] A can lid, which has a resin composition layer over at least one surface of the aluminum alloy materials for forming cans according to [4] or [5].

[7] A can body, which has a resin composition layer over at least one surface of the aluminum alloy materials for forming cans according to [4] or [5].

### Advantageous Effects of Invention

According to the present invention, a surface treatment agent, which is capable of forming a surface-treated coating having excellent corrosion resistance and adhesiveness on/over the surface of an aluminum alloy material for forming cans, can be provided. Moreover, the aluminum alloy material for forming cans having the surface-treated coating, and a can body and a can lid made of the alloy material can be provided.

### BRIEF DESCRIPTION OF DRAWINGS

FIG. 1 is a schematic view of a cut made in a test piece in a laminated film adhesiveness test 2, as an example of the present invention.

FIG. 2 is a schematic view of the maximum remaining width of a film evaluated in the laminated film adhesiveness test 2, as an example of the present invention.

### DESCRIPTION OF EMBODIMENTS

An embodiment of the present invention is a surface treatment agent to be used for an aluminum alloy material for forming cans.

The surface treatment agent according to this embodiment comprises zirconium (element), aluminum (element), a nitrate radical (NO₃_{^{−}}), and fluorine (element), and has a pH ranging from 2.0 to 4.0. Zirconium (element), aluminum (element), fluorine (element) and the like may be contained in any form in the surface treatment agent, and may be in the form of ion or complex ion. Hereinafter, zirconium (element), aluminum (element), and fluorine (element) are referred to as “zirconium”, “aluminum”, and “fluorine”, respectively.

The source of zirconium is not particularly limited as long as it can supply zirconium ions, complex ions containing zirconium and the like in the surface treatment agent. For example, zirconium oxides, zirconium hydroxides, zirconium nitrates, zirconium fluorides such as hexafluorozirconic acid, and an alkali metal salt or an ammonium salt thereof can be used. These zirconium sources may be used alone or in combination of two or more kinds thereof.

With the molar mass concentration of zirconium in the surface treatment agent ranging from 3.2 mmol/kg to 33.0mmol/kg, a good coating can be formed and the molar mass concentration may range from 3.2 mmol/kg to 11.0 mmol/kg.

The source of fluorine is not particularly limited as long as it can supply fluorine ions, complex ions containing fluorine and the like in the surface treatment agent. For example, acids such as hydrofluoric acid, ammonium fluoride, acidic ammonium fluoride, hexafluorozirconic acid, hexafluorosilicic acid, and tetrafluoroboric acid, and salts thereof can be used. These fluorine sources may be used alone or in combination of two or more kinds thereof.

With the molar mass concentration of fluorine in the surface treatment agent ranging from 52.6 mmol/kg to 526.3 mmol/kg, a good coating can be formed.

The source of aluminum is not particularly limited as long as it can supply aluminum ions, complex ions containing aluminum, and the like in the surface treatment agent. For example, metallic aluminum, aluminum oxides, aluminum hydroxides, aluminum nitrates, aluminum sulfates, and aluminate such as sodium aluminate, and aluminum fluorides such as hexafluoroaluminate, and the like can be used. These aluminum sources may be used alone or in combination of two or more kinds thereof.

With the molar mass concentration of aluminum in the surface treatment agent ranging from 14.8 mmol/kg to 74.1 mmol/kg, a good coating can be formed.

In this embodiment, it is required that the amounts of zirconium, aluminum and fluorine in the surface treatment agent satisfy the relational expression: (F−6Zr)/Al≥2.5. However, F represents the molar mass concentration of fluorine, Zr represents the molar mass concentration of zirconium, and Al represents the molar mass concentration of aluminum. When the relational expression is satisfied, a good coating can be formed. The upper limit of the above relational expression is not particularly limited, but is preferably 4.0 or less.

The source of a nitrate radical contained in the surface treatment agent is not particularly limited as long as it can supply a nitrate radical in the surface treatment agent. For example, nitric acid, and nitrates such as potassium nitrate, sodium nitrate, aluminum nitrate, and ammonium nitrate can be used. These sources of nitrate radicals may be used alone or in combination of two or more kinds thereof.

With the molar mass concentration of the nitrate radical in the surface treatment agent ranging from 16.1 mmol/kg to 161.4 mmol/kg, a good coating can be formed and the molar mass concentration may range from 16.1 mmol/kg to 80.7 mmol/kg.

The surface treatment agent of this embodiment may further comprise Bi (element), Co (element), Fe (element), Ni (element), Mg (element), and the like. These elements may be contained in any form in the surface treatment agent, and may be in the form of ion or complex ion, for example. The source of these ions or complex ions is not particularly limited. For example, metal compounds such as nitrates, sulfates, oxides, hydroxides, and fluorides of Bi, Co, Fe, Ni or Mg can be used. These compounds may be used alone or in combination of two or more kinds thereof. Through the formation of a surface-treated coating on/over the surface of an aluminum alloy material for forming cans using a surface treatment agent prepared by mixing with the metal compound, adhesiveness between a resin composition layer to be formed on the surface-treated coating and the aluminum alloy material for forming cans can be improved.

When the metal compound is mixed, the content of the metal compound in the surface treatment agent is generally 0.1 mmol/kg or more in terms of the molar mass concentration of metal atoms to be mixed. Moreover, the content is preferably 62.0 mmol/kg or less, and more preferably 41.0 mmol/kg or less. Through the formation of a surface-treated coating on/over the surface of an aluminum alloy material for forming cans using a surface treatment agent wherein the content of the metal compound is within the above range, adhesiveness between a resin composition layer to be formed on the surface-treated coating and the aluminum alloy material for forming cans can be further improved.

The surface treatment agent of this embodiment substantially contains no phosphorus compound. The term “phosphorus compound” as used herein refers to a compound containing one or more phosphorus elements in one molecule. The expression “substantially contains no phosphorus compound” means that the molar mass concentration of the phosphorus compound in the surface treatment agent is 0.1 mmol/kg or less, may be 0.05 mmol/kg or less, and may be 0.01 mmol/kg or less, and preferably no phosphorus compound is contained at all.

Moreover, it is preferable that the surface treatment agent of this embodiment substantially contains no Sn (element). Through the formation of a surface-treated coating on/over the surface of an aluminum alloy material for forming cans using a surface treatment agent substantially containing no Sn (element), a decrease in corrosion resistance of the thus formed surface-treated coating can be suppressed. The expression “substantially contains no Sn (element)” means that the molar mass concentration of Sn (element) in the surface treatment agent is 0.1 mmol/kg or less, may be 0.05 mmol/kg or less, and may be 0.01 mmol/kg or less, and preferably no Sn (element) is contained at all.

Further, the surface treatment agent of this embodiment may comprise Zn (element). Zn (element) may be contained in any form in the surface treatment agent. For example, Zn may be in the form of ion or complex ion. The source of these ions or complex ions is not particularly limited. For example, nitrates, sulfates, oxides, hydroxides, and fluorides of Zn can be used. When Zn (element) is contained, the molar mass concentration of Zn (element) in the surface treatment agent is preferably 1.5 mmol/kg or less, more preferably 0.8 mmol/kg or less. Through the formation of a surface-treated coating on/over the surface of an aluminum alloy material for forming cans using the surface treatment agent having the molar mass concentration of Zn (element) within the above range, the corrosion resistance of the thus formed surface-treated coating can be improved. The surface treatment agent may contain no Zn (element) at all.

The surface treatment agent of this embodiment may contain components other than the components described above, but preferably contains substantially no organic substance. Through the formation of a surface-treated coating on/over the surface of an aluminum alloy material for forming cans using the surface treatment agent substantially containing no organic substance, a decrease in dissolution resistance of the thus formed surface-treated coating to an acidic aqueous solution can be suppressed. In addition, the expression “substantially contains no organic substance” means that the molar mass concentration of an organic substance in the surface treatment agent (meaning the total molar mass concentration when there are a plurality of organic substances) is 0.1 mmol/kg or less, may be 0.05 mmol/kg or less, and may be 0.01 mmol/kg or less, and preferably no organic substance is contained at all.

The “pH” of the surface treatment agent of this embodiment, as described later, refers to the value at a temperature at which the surface treatment agent is placed on/over the surface of an aluminum alloy material for forming cans. The pH generally ranges from 2.0 to 4.0. Through the formation of a surface-treated coating on/over the surface of the aluminum alloy material for forming cans using the surface treatment agent having a pH within the above range, the coating performance of the thus formed surface-treated coating can be improved. The pH of the surface treatment agent can be adjusted using an acid component such as nitric acid, sulfuric acid or hydrofluoric acid, and an alkali component such as sodium hydroxide, sodium carbonate, or ammonium hydroxide.

The surface treatment agent of this embodiment can be produced, for example, by mixing a zirconium source, a fluorine source, an aluminum source, a nitrate radical source, and water. The zirconium source and the fluorine source, or the zirconium source and the nitrate radical source may be the same compounds or different compounds. Further, the aluminum source and the fluorine source, or the aluminum source and the nitrate radical source may be the same compounds or different compounds.

In another embodiment of the present invention, a surface-treated coating is formed by contacting a surface treatment agent on/over the surface of an aluminum alloy material for forming cans, and then a base coating is formed by contacting a base treatment agent over the surface of the aluminum alloy material for forming cans contacted with the surface treatment agent. In this manner, through the formation of a base coating on the surface-treated coating, adhesiveness between a resin composition layer to be provided on the base coating and the aluminum alloy material for forming cans can be improved.

The base treatment agent comprises a polymer having a repeating structure represented by the following formula (I).

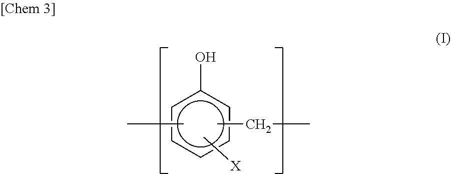

In formula (I), X is a hydrogen atom or a Z group represented by the following formula (II)

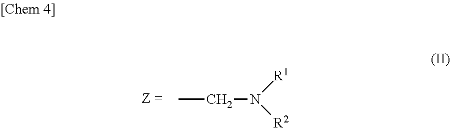

(in formula (II), R¹ and R² are each independently an alkyl group having 10 or less carbon atoms or a hydroxyl alkyl group having 10 or less carbon atoms.), wherein the introduction rate of the Z group ranges from 0.3 to 1.0 per benzene ring. The introduction rate of the Z group can be calculated from quantitative results found by, for example, completely burning the polymer and measuring the generated gas (CO₂, H₂O, N₂, SO₂) on the basis of CHNS—O elemental analysis to quantify each element.

The weight average molecular weight of the polymer ranges from 1,000 to 100,000 when all Xs are hydrogen atoms. The weight average molecular weight can be found, for example, in terms of polystyrene as measured by gel permeation chromatography.

The base treatment agent may comprise the polymer and water, and may further comprise other components such as an acid component. The production method is not particularly limited. For example, the base treatment agent can be prepared by mixing a polymer, water, and an acid-based compound as necessary. Examples of the acid-based compound that can be used herein include, but are not limited to: inorganic acids such as phosphoric acid, phosphorous acid, hypophosphorous acid, nitric acid, and sulfuric acid; fluorides such as hydrofluoric acid, hexafluorozirconic acid, hexafluorotitanic acid, tetrafluoroboric acid, and acidic ammonium fluoride; organic acids or salts thereof such as formic acid, acetic acid, oxalic acid, lactic acid, citric acid, zirconium acetate, titanium acetate, and aluminum acetate. These compounds may be used alone or in combination of two or more kinds thereof.

The concentration of a polymer in the base treatment agent is not particularly limited, but is generally 0.01 g/L or more, and preferably 0.05 g/L or more. Moreover, the concentration is generally 30 g/L or less, and preferably 10 g/L or less. Through the formation of a base coating on the surface-treated coating using the base treatment agent in which the concentration of the polymer is within the above range, adhesiveness between a resin composition layer to be provided on the base coating and the aluminum alloy material for forming cans can be improved.

When an acid-based compound is contained in the base treatment agent, the concentration of the acid-based compound is not particularly limited, and is generally 0.01 g/L or more, and preferably 0.05 g/L or more. Further, the concentration is generally 30 g/L or less, and preferably 5 g/L or less. Through the formation of a base coating on the surface-treated coating using the base treatment agent in which the concentration of the acid-based compound is within the above range, adhesiveness between a resin composition layer to be provided on the base coating and an aluminum alloy material for forming cans can be improved. The pH of the base treatment agent is not particularly limited, but as described later, the value at a temperature at which the base treatment agent contacting over the surface of the aluminum alloy material for forming cans having a surface-treated coating preferably ranges from 3.0 to 6.0

Next, a method for producing an aluminum alloy material for forming cans will be described.

Other embodiments of the present invention are a method for producing an aluminum alloy material for forming cans having a surface-treated coating, and a method for producing an aluminum alloy material for forming cans having a multilayer coating comprising a surface-treated coating and a base coating. Other embodiments thereof are aluminum alloy materials for forming cans, which are obtained by these methods.

Note that the multilayer coating comprises a surface-treated coating and a base coating, and may also contain a coating other than these coatings.

### (Aluminum Alloy Material for Forming Cans)

Materials for the aluminum alloy materials for forming cans used in these embodiments are not particularly limited as long as these materials are used for aluminum cans. Preferred examples thereof include aluminum-manganese alloy materials (A3000 series) and aluminum-magnesium alloy materials (A5000 series).

It is preferable to clean the surface of the aluminum alloy material for forming cans prior to the formation of a surface-treated coating. A method for cleaning the surface is not particularly limited, and examples thereof can include a degreasing method. Degreasing agents to be used in the degreasing method are not particularly limited, and examples thereof include generally used organic solvents, alkaline degreasing agents, and acidic degreasing agents.

(Method for Producing Aluminum Alloy Material for Forming Cans having Surface-Treated Coating)

A method for producing an aluminum alloy material for forming cans having a surface-treated coating comprises a step of contacting the above-described surface treatment agent on/over the surface of an aluminum alloy material for forming cans. The production method may also comprise, after contacting the surface treatment agent, a step of drying the surface treatment agent contacted.

A method for contacting the surface treatment agent with an aluminum alloy material for forming cans is not particularly limited, and examples thereof include an immersion method, a spray treatment method, and a pouring method. The contact time is appropriately set, but generally ranges from 1 to 20 seconds, and when the surface treatment agent is sprayed over the aluminum alloy material for forming cans, preferably ranges from 2 to 10 seconds. Temperatures for contact between the surface treatment agent and the aluminum alloy material for forming cans are not particularly limited, and generally ranges from 40° C. to 70° C.

(Surface-Treated Coating)

The adhesion amount of a surface-treated coating to be formed on/over the surface of an aluminum alloy material for forming cans is generally 1 mg/m² or more, preferably 2 mg/m² or more, generally 50 mg/m² or less, and preferably 30 mg/m² or less in terms of the mass of zirconium atoms per unit area. When the adhesion amount of a surface-treated coating is within the above range, adhesiveness between a resin composition layer to be formed on the surface-treated coating and the aluminum alloy material for forming cans can be further improved.

(Method for Producing Aluminum Alloy Material for Forming Cans having Multilayer Coating)

The method for producing the aluminum alloy material for forming cans having the above-described multilayer coating comprises a step of contacting the above-described base treatment agent over the surface of the aluminum alloy material for forming cans having a surface-treated coating. The production method may also comprise, after contacting the base treatment agent, a step of drying the base treatment agent contacted.

A method for contacting the base treatment agent with the aluminum alloy material for forming cans is not particularly limited and an example thereof is a method of coating. Specific examples thereof include a roll coating method, a bar coating method, a spray treatment method, and an immersion treatment method. Generally, it can be performed by applying the base treatment agent to a surface (the surface having a surface-treated coating) to be contacted with the aluminum alloy material for forming cans by roll coating, wringing with a shower wringer, or the like. Temperatures for the base treatment agent upon coating are not particularly limited, and in general range from preferably 15° C. to 65° C. Subsequently, the base treatment agent, or the surface treatment agent and the base treatment agent are generally dried. The drying conditions at this time are not particularly limited. For example, drying is generally performed at 80° C. to 250° C. for 2 to 60 seconds.

(Base Coating)

The adhesion amount of a base coating to be formed on the surface-treated coating of the aluminum alloy material for forming cans is generally 0.1 mg/m² or more, preferably 0.5 mg/m² or more, and is generally 30 mg/m² or less and preferably 20 mg/m² or less in terms of the mass of carbon per unit area. When the adhesion amount of the base coating is within the above range, adhesiveness between the resin composition layer to be provided on the base coating and the aluminum alloy material for forming cans can be further improved.

Next, a method for producing a can lid and a can body will be described.

Other embodiments of the present invention are a can lid and a can body, each of which has a resin composition layer over at least one surface of an aluminum alloy material for forming cans having a surface-treated coating and an aluminum alloy material for forming cans having a multilayer coating comprising a surface-treated coating and a base coating.

(Resin Composition Layer)

On the aluminum alloy material for forming cans having a surface-treated coating, or, on the aluminum alloy material for forming cans having a multilayer coating comprising a surface-treated coating and a base coating, a resin composition layer may also be formed. The resin composition layer may be one or two or more coating films, or a laminated film. The shape of the resin composition layer is not particularly limited, and the resin composition layer, which is typically plate-shaped, sheet-shaped, film-shaped, or the like, is used.

When the resin composition layer is a coating film, a method for forming the coating film is not particularly limited. Examples thereof include roll coater coating and spray coating, and may include a method employing these techniques in combination.

A paint to be used to form a coating film is not particularly limited, and examples thereof include a paint containing a thermosetting resin and a paint containing a thermoplastic resin, and a paint containing a thermosetting resin is preferable.

Examples of the thermosetting resin are not particularly limited, and include a phenol-formaldehyde resin, a furan-formaldehyde resin, a xylene-formaldehyde resin, a ketone-formaldehyde resin, a urea-formaldehyde resin, a melamine-formaldehyde resin, an alkyd resin, an unsaturated polyester resin, an epoxy resin, a bismaleimide resin, a triallyl cyanurate resin, a thermosetting acrylic resin, a silicone resin, and an oil resin.

Examples of the thermoplastic resin are not particularly limited and include a vinyl chloride-vinyl acetate copolymer, a partially saponified vinyl chloride-vinyl acetate copolymer, a vinyl chloride-maleic acid copolymer, a vinyl chloride-maleic acid-vinyl acetate copolymer, an acrylic polymer, and a saturated polyester resin.

Above resins to be contained in a paint may be used one kind, or two or more kinds thereof.

When the resin composition layer is a laminated film, the pasting method is not particularly limited, and a known method can be applied. Specific examples thereof can include a dry lamination method and an extrusion lamination method. Moreover, a resin adhesive may also be applied and then pasted on the aluminum alloy material for forming cans having a surface-treated coating, on the aluminum alloy material for forming cans having a multilayer coating comprising the surface-treated coating and the base coating, or on the surface on which the laminated film is pasted.

A resin composition to be used for the laminated film is not particularly limited, but is preferably a thermoplastic resin, and particularly, a polyester resin or a polyolefin resin is preferable. In particular, polyethylene terephthalate, polybutylene terephthalate, polynaphthalene terephthalate, or a polyester resin selected from these blended resins is most preferable as a thermoplastic resin.

The aluminum alloy material for forming cans, on which a resin composition layer is formed, can be shaped into a can lid or a can body. Known methods are applicable to such shaping of a can lid or a can body.

### EXAMPLES

The present invention will be described in more detail based on Examples below, but the present invention is not limited by these Examples. In addition, the unit is based on mass unless otherwise specified.

Preparation of Surface Treatment Agent

### Example 1

A surface treatment agent 1 having the composition described in Table 1-1 was prepared. The surface treatment agent 1 was prepared by adding the following components (A) to (D) to water with a volume accounting for 80% of the total volume in order of (D), (C), (B), and (A), finally making up to volume with water, and then stirring at normal temperature for 10 minutes. Subsequently, the temperature was increased to the contact temperature described in Table 1-1 for pH adjustment, and then adjustment was performed using ammonium hydroxide so as to obtain the pH described in Table 1-1.
(A) Hexafluorozirconic acid
(B) Aluminum hydroxide
(C) Hydrofluoric acid
(D) Nitric acid

### Examples 2 to 13, Examples 29 to 34, Examples 37 to 41, and Comparative Examples 1 to 6

The molar mass concentrations and sources of zirconium, the molar mass concentrations and sources of aluminum, the molar mass concentrations of fluorine, the molar mass concentrations of a nitrate radical, pH, contact temperatures, and contact time were set according to conditions listed in Tables 1-1 and 2-1, and other conditions were the same as those in Example 1, and thus the surface treatment agents of Examples 2 to 13, Examples 29 to 34, Examples 37 to 41 and Comparative Examples 1 to 6 were prepared.

### Example 14

A surface treatment agent 14 having the composition described in Table 1-1 was prepared. The surface treatment agent 14 was prepared by adding the following components (A) to (E) to water with a volume accounting for 80% of the total volume in order of (D), (C), (B), (A) and (E), finally making up to volume with water, and then stirring at normal temperature for 10 minutes. Subsequently, the temperature was increased to the contact temperature described in Table 1-1 for pH adjustment, and then adjustment was performed using ammonium hydroxide so as to obtain the pH described in Table 1-1.
(A) Zirconium oxynitrate
(B) Aluminum nitrate
(C) Hydrofluoric acid
(D) Nitric acid
(E) Cobalt nitrate

### Examples 15 to 28 and Examples 35 and 36

The molar mass concentrations and sources of zirconium, the molar mass concentrations and sources of aluminum, the molar mass concentrations of fluorine, the molar mass concentrations of a nitrate radical, pH, contact temperatures, contact time, the molar mass concentrations in terms of the metal atoms of other metal elements, and the sources of other metal elements were set as listed in Table 1-1, other conditions were the same as those in Example 14, and thus the surface treatment agents of Examples 15 to 28, and Examples 35 and 36 were prepared.

Preparation of Base Treatment Agent

### Base Treatment Agent: Example 29

Regarding a polymer to be used for the base treatment agent, a polymer having a weight average molecular weight of 1000, when a Z group is CH₂N(CH₃)₂ in the structural unit represented by formula (I) and the introduction rate of the Z group is 0.5 per benzene ring, and all Xs are hydrogen atoms, was used.

Ion exchange water was introduced into a vessel with a stirrer, and 85% phosphoric acid (concentration: 15 g/L) and the polymer (concentration: 40 g/L) were added and dissolved while stirring at normal temperature. Subsequently, the solution was diluted with ion exchange water so that the concentration of the polymer was 0.60 g/L.

### Base Treatment Agent: Examples 30 to 41 and Comparative Example 6

The weight average molecular weight of the polymer, the introduction rate of the Z group, and the kinds of acid-based compounds were set according to the conditions listed in Tables 1-1 and 2-1, the other conditions were the same as those in Example 29, and thus the base treatment agents of Examples 30 to 41 and Comparative Example 6 were prepared.

### Surface Treatment of Aluminum Alloy Sheet: Examples 1 to 28 and Comparative Examples 1 to 5

Commercially available aluminum-magnesium alloy sheets (JIS A5182 material, sheet thickness: 0.25 mm) and aluminum-manganese alloy sheets (JIS A3104 material, sheet thickness: 0.285 mm) were prepared. The sheets were washed by spraying a 2% aqueous solution of a commercially available alkaline degreaser (Fine Cleaner 4477; Nihon Parkerizing Co., Ltd.) at 60° C. for 6 seconds, and then washed with water. Further, the sheets were washed with a 2% aqueous sulfuric acid solution at 50° C. for 2 seconds, and then washed with water. Subsequently, the sheets were subjected to surface treatment with the surface treatment agents prepared in the above Examples and Comparative Examples by spraying under the conditions of contact temperatures for the contact time as listed in Tables 1-1 and 2-1. The sheets were then washed with tap water, further spray-washed with deionized water, wrung with a draining roller, and then dried at an ultimate metal peak temperature of 70° C. for 10 seconds, thereby preparing aluminum alloy sheets having surface-treated coatings.

### Base Treatment of Aluminum Alloy Sheet: Examples 29 to 41 and Comparative Example 6

In a manner similar to Examples 1 to 28 and Comparative Examples 1 to 5, aluminum alloy sheets were subjected to surface treatment using the above-prepared surface treatment agents. Subsequently, base treatment was performed using the above-prepared base treatment agents. The adhesion amount of a base-treated coating was adjusted by varying the concentration of a polymer in each base treatment agent. Base treatment was performed by applying the base treatment agent using a bar coater #5, wherein the concentration of a polymer was adjusted with deionized water in such a manner that the adhesion amount of a base-treated coating was as listed in Tables 1-1 and 2-1 in terms of the mass of carbon per unit area. Each aluminum alloy sheet coated with the base treatment agent was dried at 200° C. for 20 seconds using an automatic discharge type oven, thereby preparing an aluminum alloy sheet having a surface-treated coating and a base-treated coating.

The adhesion amount in terms of the mass of zirconium atoms per unit area of the surface-treated coating and the adhesion amount in terms of the mass of carbon per unit area of the base coating of each aluminum alloy sheet subjected to surface treatment or surface treatment and base treatment were quantified using a scanning fluorescent X-ray analyzer (ZSX Primusll; Rigaku Corporation).

(Preparation of Coated Sheet)

The surface on the side, where the surface-treated coating had been formed, of each of the aluminum alloy sheets having surface-treated coatings prepared in Examples 1 to 28 and Comparative Examples 1 to 5 above was coated with a commercially available water-based epoxy acrylic paint using a bar coater #18 in such a manner that the coating film amount after drying was 70 mg/dm². Subsequently, the aluminum alloy sheet was heated for 60 seconds using an automatic discharge oven under conditions of a temperature of 260° C. and a wind speed of 1 to 30 m/min to form a coating film, thereby preparing a coated sheet.

(Preparation of Laminated Sheet)

The aluminum alloy sheets having surface-treated coatings prepared in Examples 1 to 28 and Comparative Examples 1 to 5 above, and aluminum alloy sheets having surface-treated coatings and base coatings prepared in Examples 29 to 41 and Comparative Example 6 above were heated in advance at a sheet temperature of 250° C. A polyethylene terephthalate film (film thickness 20 μm) was thermally pressed onto one side or both sides of each alloy sheet via a laminating roll and then the sheet was immediately cooled with water, thereby preparing a laminated sheet.

Evaluation of Aluminum Alloy Sheet

(Coating Dissolution Resistance Test for the Resistance of Surface-Treated Coating to Acidic Solution)

Coating dissolution resistance of the aluminum alloy sheets having surface-treated coatings of Examples 1 to 41 and Comparative Examples 1 to 6 was tested by immersing the aluminum alloy sheets having surface-treated coatings in an acidic test solution 1. The acidic test solution 1 containing 500 ppm of sodium chloride and 500 ppm of citric acid was used. Moreover, the temperature of the acidic test solution 1 at the time of the test was 50° C., and each aluminum alloy sheet was immersed for 5 hours. The test pieces were then washed with deionized water and then dried at room temperature. Evaluation was made on the basis of the residual rate found from the adhesion amount in terms of the mass of zirconium atoms per unit area of the surface-treated coating remaining on the test piece surface after the test and the residual rate found from the adhesion amount in terms of the mass of zirconium atoms per unit area of the surface-treated coating present on the test piece surface before the test. The higher the coating dissolution resistance of the aluminum alloy sheet is, the higher the residual rate of the surface-treated coating is after the test.

Evaluation criteria were as follows, and those scored as S and A were considered as Passed. The evaluation results are shown in Table 1-2 and Table 2-2.
S: Residual rate 80% or more to 100% or less
A: Residual rate 60% or more to less than 80%
B: Residual rate 40% or more to less than 60%
C: Residual rate 0% or more to less than 40%

(Laminated Film Adhesiveness Test 1)

The laminated aluminum alloy sheets (aluminum-manganese alloy sheet: JIS A3104 material) prepared in Examples 1 to 41 and Comparative Examples 1 to 6 were cut into a size of 50 mm×50 mm to obtain test pieces. Each test piece was placed in a way that the evaluation surface on which the laminated film had been provided to be the outer side, and then a 1000 g weight with a diameter of 12.7 mm (½ inch) was dropped from a height of 150 mm using a Dupont impact tester onto each test piece, followed by processing. Subsequently, the evaluation surface of the test piece processed by the Dupont impact tester was subjected to cross-cutting in a grid pattern with an NT cutter. In addition, cross-cutting in a grid pattern was performed so that 11 parallel lines at intervals of 2 mm were crossed at right angles, thereby preparing 100 squares. The test piece was then immersed in boiling pure water for 30 minutes, removed, and then left to stand at room temperature for 30 minutes for drying. The evaluation surface was then peeled off using a Nichiban adhesive tape with a width of 24 mm. Adhesiveness was evaluated by counting the squares where the laminated film remained among 100 squares. Evaluation criteria were as follows. The evaluation results are shown in Table 1-2 and Table 2-2.
S: Squares with the laminated film remaining thereon 100/100
A: Squares with the laminated film remaining thereon 90/100 to 99/100
B: Squares with the laminated film remaining thereon 80/100 to 89/100
C: Squares with the laminated film remaining thereon 0/100 to 79/100

(Laminated Film Adhesiveness Test 2)

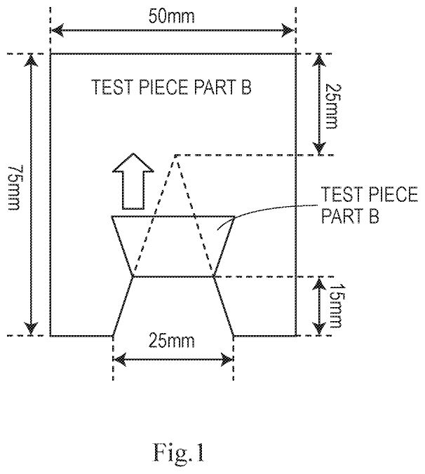

The laminated aluminum alloy sheets (aluminum-magnesium alloy sheet: JIS A5182 material) prepared in Examples 1 to 41 and Comparative Examples 1 to 6 were each cut into a size with lengths of 75 mm (in a direction perpendicular to the rolling direction, hereinafter also referred to as a long side)×50 mm (in a direction into the rolling direction, hereinafter, also referred to as a short side). As shown in FIG. 1, a cut of an isosceles triangle having a base of 25 mm and a height of 50 mm was made using a cutter from one of the short sides onto the back side of the laminated surface of each cut laminated aluminum alloy sheet. Note that the base of the isosceles triangle was made to match the short side of the cut laminated aluminum alloy sheet and both center points were also made to match. The laminated aluminum alloy sheet was cut from the aluminum alloy by about 15 mm along the cut made using the cutter, from the base to the top of the isosceles triangle, and then bent as it was, thereby preparing a test piece.

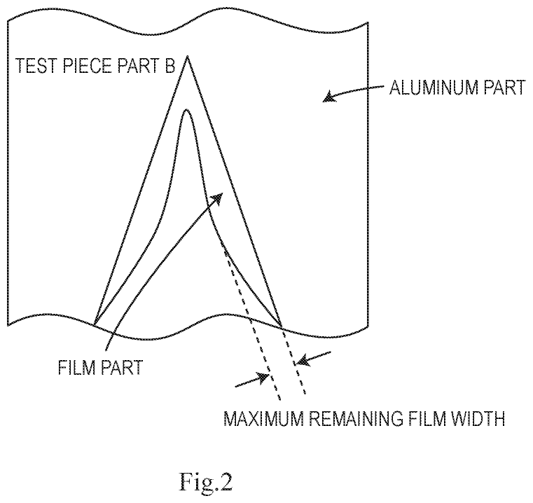

The test piece was placed and immersed in pure water in an autoclave at 125° C. for 30 minutes, removed, and then kept in pure water at 80° C. Just before the test, the test piece was removed from pure water at 80° C., the bent portion of the isosceles triangle and the outer portion were sandwiched by a tensile tester and pulled in the long side direction (longitudinal direction) at a tensile speed of 200 mm/min. As shown in FIG. 2, the maximum remaining film width remaining on the test piece part B after the test was measured and evaluated. Evaluation criteria were as follows. The evaluation results are shown in Table 1-2 and Table 2-2.
A: Maximum remaining film width Less than 0.5 mm
B: Maximum remaining film width 0.5 mm or more, less than 1.0 mm
C: Maximum remaining film width 1.0 mm or more

(Corrosion Test of Coating Film)

The aluminum alloy sheets (aluminum-magnesium alloy sheet: JIS A5182 material) after coating of Examples 1 to 28 and Comparative Examples 1 to 5 were cut into a size of 50 mm×50 mm and used as test pieces. The non-coated surface of each test piece was back-sealed, and the coated surface was cross-cutting using an NT cutter into a size of 50 mm×50 mm. Subsequently, the test piece was immersed for 1 week in an acidic test solution 2 containing 500 ppm of sodium chloride and 1000 ppm of citric acid in a closed container under an environment of 70° C., washed with deionized water, and then dried at room temperature. The degree of corrosion after drying was evaluated based on the maximum diameter of a float (blister) of the coating film generated on the flat portion due to corrosion and the maximum peeling width (cut width) of the cross-cut portion. Evaluation criteria were as follows, and test pieces scored as A were considered as Passed. The evaluation results are shown in Table 1-2 and Table 2-2.

<Blister>
A: Maximum diameter Less than 1 mm
B: Maximum diameter 1 mm or more, less than 3 mm
C: Maximum diameter 3 mm or more

<Cut Width>
A: Less than 0.1 mm
B: 0.1 mm or more, less than 1.0 mm
C: 1.0 mm or more

TABLE 1-1

| | | | | | | | | | | | | | surface |
|---|---|---|---|---|---|---|---|---|---|---|---|---|---|
| | surface treatment agent | | | | | | | | | | | | treatment |
| | | | | | | | | | | | | supply | condition |
| | | Zr | supply | Al | supply | F | NO₃ | | | | | source of | contact |
| | | (mmol/ | source | (mmol/ | source | (mmol/ | (mmol/ | (F—6Zr)/ | | other metals | | other metal | time |
| | No | kg) | of Zr | kg) | of Al | kg) | kg) | Al | pH | (mmol/kg) | | elements | (s) |
| Example | 1 | 3.3 | H₂ZrF₆ | 14.8 | Al(OH)₃ | 61.2 | 16.1 | 2.8 | 3.5 | — | — | — | 8 |
| | 2 | 4.4 | H₂ZrF₆ | 18.5 | Al(OH)₃ | 78.2 | 32.2 | 2.8 | 3.0 | — | — | — | 4 |
| | 3 | 5.5 | ZrO(NO₃)₂ | 22.2 | Al(NO3)₃ | 95.2 | 80.7 | 2.8 | 3.5 | — | — | — | 4 |
| | 4 | 3.3 | H₂ZrF₆ | 25.9 | Al(NO₃)₃ | 97.5 | 80.7 | 3.0 | 2.5 | — | — | — | 1 |
| | 5 | 4.4 | ZrO(NO₃)₂ | 29.6 | Al₂(SO₄)₃ | 112.2 | 48.3 | 2.9 | 3.0 | — | — | — | 3 |
| | 6 | 5.5 | H₂ZrF₆ | 37.0 | Al(OH)₃ | 136.6 | 32.2 | 2.8 | 3.0 | — | — | — | 6 |
| | 7 | 9.9 | H₂ZrF₆ | 74.1 | Al(OH)₃ | 303.9 | 48.3 | 3.3 | 3.0 | — | — | — | 3 |
| | 8 | 7.7 | H₂ZrF₆ | 55.5 | Al(OH)₃ | 201.6 | 64.5 | 2.8 | 2.5 | — | — | — | 10 |
| | 9 | 3.3 | H₂ZrF₆ | 44.4 | Al(OH)₃ | 130.8 | 32.2 | 2.5 | 3.0 | — | — | — | 3 |
| | 10 | 11.0 | H₂ZrF₆ | 33.3 | Al(OH)₃ | 182.6 | 48.3 | 3.5 | 3.5 | — | — | — | 4 |
| | 11 | 7.7 | ZrO(NO₃)₂ | 37.0 | Al(NO₃)₃ | 149.8 | 160.0 | 2.8 | 3.3 | — | — | — | 3 |
| | 12 | 33.0 | H₂ZrF₆ | 37.0 | Al(OH)₃ | 301.6 | 32.2 | 2.8 | 3.0 | — | — | — | 2 |
| | 13 | 33.0 | H₂ZrF₆ | 74.0 | Al(OH)₃ | 494.0 | 160.0 | 4.0 | 3.0 | — | — | — | 2 |
| | 14 | 5.5 | ZrO(NO₃)₂ | 22.2 | Al(NO3)₃ | 95.2 | 80.7 | 2.8 | 3.0 | Co | 0.9 | Co(NO₃)₂ | 4 |
| | 15 | 3.3 | H₂ZrF₆ | 25.9 | Al(NO₃)₃ | 97.5 | 80.7 | 3.0 | 2.5 | Co | 3.4 | CoSO₄ | 1 |
| | 18 | 3.3 | H₂ZrF₆ | 14.8 | Al(OH)₃ | 61.2 | 16.1 | 2.8 | 3.5 | Bi | 0.1 | Bi(NO₃)₃ | 8 |
| | 17 | 4.4 | (NH₄)₂ZrF₆ | 18.5 | Al(OH)₃ | 78.2 | 32.2 | 2.8 | 3.0 | Bi | 4.7 | Bi₂O₃ | 4 |
| | 18 | 4.4 | H₂ZrF₆ | 29.8 | Al₂(SO₄)₃ | 121.1 | 48.3 | 3.2 | 3.0 | Fe | 3.6 | Fe(NO₃)₃ | 3 |
| | 19 | 5.5 | Na₂ZrF₆ | 37.0 | Al(OH)₃ | 140.3 | 32.2 | 2.9 | 3.0 | Fe | 0.9 | Fe(NO₃)₃ | 6 |
| | 20 | 9.9 | H₂ZrF₆ | 74.1 | Al(OH)₃ | 303.9 | 48.3 | 3.3 | 3.0 | Ni | 3.4 | Ni(NO₃)₂ | 3 |
| | 21 | 7.7 | (NH₄)₂ZrF₆ | 55.5 | Al(OH)₃ | 201.6 | 64.5 | 2.8 | 2.5 | Ni | 0.4 | Ni(NO₃)₂ | 10 |
| | 22 | 4.4 | (NH₄)₂ZrF₆ | 18.5 | Al(OH)₃ | 78.2 | 32.2 | 2.8 | 3.0 | Mg | 8.2 | Mg(NO₃)₂ | 3 |
| | 23 | 11.0 | (NH₄)₂ZrF₆ | 74.1 | Al(OH)₃ | 362.4 | 64.5 | 4.0 | 3.0 | Mg | 33.0 | Mg(NO₃)₂ | 4 |
| | 24 | 3.3 | H₂ZrF₆ | 44.4 | Al(OH)₃ | 130.8 | 32.2 | 2.5 | 3.0 | Bi: 0.1 | 1.0 | Bi₂O₃ | 3 |
| | | | | | | | | | | Co: 0.9 | | Co(NO₃)₂ | |
| | 25 | 11.0 | (NH₄)₂ZrF₆ | 33.3 | Al(OH)₃ | 182.6 | 48.3 | 3.5 | 3.5 | Ni: 3.4 | 4.3 | Ni(NO₃)₂ | 4 |
| | | | | | | | | | | Fe: 0.9 | | Fe(NO₃)₃ | |
| | 26 | 7.7 | ZrO(NO₃)₂ | 37.0 | Al(NO₃)₃ | 149.8 | 160.0 | 2.8 | 3.3 | Mg | 8.2 | Mg(NO₃)₂ | 3 |
| | 27 | 33.0 | H₂ZrF₆ | 37.0 | Al(OH)₃ | 301.6 | 32.2 | 2.8 | 3.0 | Fe | 0.9 | Fe(NO₃)₃ | 2 |
| | 28 | 33.0 | (NH₄)₂ZrF₆ | 74.0 | Al(OH)₃ | 494.0 | 160.0 | 4.0 | 3.0 | Fe | 3.6 | Fe(NO₃)₃ | 2 |
| | 29 | 11.0 | H₂ZrF₆ | 37.0 | Al(OH)₃ | 169.6 | 32.2 | 2.8 | 2.5 | — | — | — | 4 |
| | 30 | 3.3 | H₂ZrF₆ | 14.8 | Al(OH)₃ | 61.2 | 16.1 | 2.8 | 3.5 | — | — | — | 8 |
| | 31 | 5.5 | ZrO(NO₃)₂ | 22.2 | Al(NO3)₃ | 95.2 | 80.7 | 2.8 | 3.5 | — | — | — | 4 |
| | 32 | 3.3 | H₂ZrF₆ | 25.9 | Al(OH)₃ | 97.5 | 64.5 | 3.0 | 2.5 | — | — | — | 1 |
| | 33 | 4.4 | ZrO(NO₃)₂ | 29.6 | Al₂(SO₄)₃ | 112.2 | 48.3 | 2.9 | 3.0 | — | — | — | 3 |
| | 34 | 5.5 | H₂ZrF₆ | 37.0 | Al(OH)₃ | 136.6 | 24.1 | 2.8 | 3.0 | — | — | — | 6 |
| | 35 | 9.9 | H₂ZrF₆ | 74.1 | Al(OH)₃ | 303.9 | 40.3 | 3.3 | 3.0 | Bi | 0.1 | Bi(NO₃)₃ | 3 |
| | 38 | 7.7 | H₂ZrF₆ | 55.5 | Al(OH)₃ | 201.6 | 64.5 | 2.8 | 2.5 | Mg | 33.0 | Mg(NO₃)₂ | 10 |
| | 37 | 3.3 | H₂ZrF₆ | 44.4 | Al(OH)₃ | 130.8 | 32.2 | 2.5 | 3.0 | — | — | — | 3 |
| | 38 | 5.5 | H₂ZrF₆ | 33.3 | Al(OH)₃ | 149.6 | 48.3 | 3.5 | 3.5 | — | — | — | 4 |
| | 39 | 7.7 | ZrO(NO₃)₂ | 37.0 | Al(NO₃)₃ | 149.8 | 160.0 | 2.8 | 3.3 | — | — | — | 3 |
| | 40 | 33.0 | H₂ZrF₆ | 37.0 | Al(OH)₃ | 301.6 | 32.2 | 2.8 | 3.0 | — | — | — | 2 |
| | 41 | 33.0 | H₂ZrF₆ | 74.0 | Al(OH)₃ | 494.0 | 160.0 | 4.0 | 3.0 | — | — | — | 2 |

| | | | | base treatment agent, conditions | | | | | |
|---|---|---|---|---|---|---|---|---|---|
| | | surface treatment condition | | adhesion | | weight | | | |
| | | | adhesion | amount | introduction | average | | | acid |
| | | contact | amount | of | rate of | molecular | polymer | addition | compounds |
| | | temperature | of Zr | carbon | Z group of | weight of | content | of acid | Content |
| | No | (C.) | (mg/m²) | (mg/m²) | polymer | polymer | (g/L) | compounds | (g/L) |
| Example | 1 | 55 | 12 | — | — | — | — | — | — |
| | 2 | 55 | 10 | — | — | — | — | — | — |
| | 3 | 55 | 12 | — | — | — | — | — | — |
| | 4 | 55 | 1 | — | — | — | — | — | — |
| | 5 | 40 | 2 | — | — | — | — | — | — |
| | 6 | 55 | 15 | — | — | — | — | — | — |
| | 7 | 50 | 13 | — | — | — | — | — | — |
| | 8 | 55 | 30 | — | — | — | — | — | — |
| | 9 | 65 | 9 | — | — | — | — | — | — |
| | 10 | 55 | 16 | — | — | — | — | — | — |
| | 11 | 55 | 10 | — | — | — | — | — | — |
| | 12 | 55 | 25 | — | — | — | — | — | — |
| | 13 | 55 | 20 | — | — | — | — | — | — |
| | 14 | 55 | 12 | — | — | — | — | — | — |
| | 15 | 55 | 1 | — | — | — | — | — | — |
| | 18 | 55 | 12 | — | — | — | — | — | — |
| | 17 | 55 | 10 | — | — | — | — | — | — |
| | 18 | 40 | 2 | — | — | — | — | — | — |
| | 19 | 55 | 15 | — | — | — | — | — | — |
| | 20 | 50 | 13 | — | — | — | — | — | — |
| | 21 | 55 | 30 | — | — | — | — | — | — |
| | 22 | 55 | 8 | — | — | — | — | — | — |
| | 23 | 55 | 6 | — | — | — | — | — | — |
| | 24 | 65 | 9 | — | — | — | — | — | — |
| | 25 | 55 | 16 | — | — | — | — | — | — |
| | 26 | 55 | 10 | — | — | — | — | — | — |
| | 27 | 55 | 25 | — | — | — | — | — | — |
| | 28 | 55 | 20 | — | — | — | — | — | — |
| | 29 | 55 | 16 | 4 | 0.5 | 1000 | 0.60 | phosphoric acid | 0.19 |
| | 30 | 55 | 12 | 10 | 0.5 | 3000 | 1.50 | phosphoric acid | 0.48 |
| | 31 | 55 | 12 | 4 | 0.5 | 1500 | 0.60 | phosphoric acid | 0.19 |
| | 32 | 55 | 1 | 4 | 0.3 | 5000 | 0.60 | phosphoric acid | 0.19 |
| | 33 | 40 | 2 | 4 | 0.75 | 10000 | 0.60 | phosphoric acid | 0.19 |
| | 34 | 55 | 15 | 1 | 1.0 | 50000 | 0.15 | phosphoric acid | 0.05 |
| | 35 | 50 | 13 | 10 | 0.75 | 5000 | 1.50 | phosphoric acid | 0.48 |
| | 38 | 55 | 30 | 20 | 1.0 | 100000 | 3.00 | phosphoric acid | 0.96 |
| | 37 | 65 | 9 | 30 | 0.75 | 5000 | 4.50 | hydrofluoric acid | 0.60 |
| | 38 | 55 | 16 | 10 | 0.75 | 5000 | 1.50 | H₂ZrF₆ | 1.50 |
| | 39 | 55 | 10 | 4 | 0.5 | 5000 | 0.60 | phosphoric acid | 0.19 |
| | 40 | 55 | 25 | 4 | 0.5 | 5000 | 0.60 | phosphoric acid | 0.19 |
| | 41 | 55 | 20 | 4 | 0.5 | 5000 | 0.60 | phosphoric acid | 0.19 |

※ Shows the weight average molecular weight when x in the formula (I) in the polymer is all hydrogen atoms.

TABLE 1-2

| | test | | | | |
|---|---|---|---|---|---|
| | coating | | | | |
| | dissolution | corrosion test | | laminated film | |
| | resistance | of coating film | | adhesiveness | |
| | aluminum alloy material | | | | |
| | | A5182 | | A3104 | A5182 |
| | | material | | material | material |
| | A5182 | | cut | adhesiveness | adhesiveness |
| | material | blister | width | test1 | test2 |
| Example1 | S | A | A | A | B |
| Example2 | S | A | A | A | B |
| Example3 | S | A | A | A | B |
| Example4 | S | A | A | B | C |
| Example5 | S | A | A | B | C |
| Example6 | S | A | A | A | B |
| Example7 | S | A | A | A | B |
| Example8 | S | A | A | B | C |
| Example9 | S | A | A | A | C |
| Example10 | S | A | A | A | C |
| Example11 | S | A | A | A | B |
| Example12 | S | A | A | A | B |
| Example13 | S | A | A | A | B |
| Example14 | S | A | A | A | B |
| Example15 | S | A | A | A | B |
| Example16 | S | A | A | A | B |
| Example17 | S | A | A | A | B |
| Example18 | S | A | A | A | B |
| Example19 | S | A | A | A | B |
| Example20 | S | A | A | A | B |
| Example21 | S | A | A | A | B |
| Example22 | S | A | A | A | B |
| Example23 | S | A | A | A | B |
| Example24 | S | A | A | A | B |
| Example25 | S | A | A | A | B |
| Example26 | S | A | A | A | B |
| Example27 | S | A | A | A | B |
| Example28 | S | A | A | A | B |
| Example29 | S | — | — | S | A |
| Example30 | S | — | — | S | A |
| Example31 | S | — | — | S | A |
| Example32 | S | — | — | S | A |
| Example33 | S | — | — | S | A |
| Example34 | S | — | — | S | A |
| Example35 | S | — | — | S | A |
| Example36 | S | — | — | S | A |
| Example37 | S | — | — | A | A |
| Example38 | S | — | — | S | A |
| Example39 | S | — | — | S | A |
| Example40 | S | — | — | S | A |
| Example41 | S | — | — | S | A |

TABLE2-1

| | surface treatment agent | | | | | | | | | | | | surface |
|---|---|---|---|---|---|---|---|---|---|---|---|---|---|
| | | | | | | | | | | | | supply | treatment |
| | | Zr | supply | Al | supply | F | NO₃ | | | | | source of | contact |
| | | (mmol/ | source | (mmol/ | source | (mmol/ | (mmol/ | (F—6Zr)/ | | other metals | | other metal | time |
| | No | kg) | of Zr | kg) | of Al | kg) | kg) | Al | pH | (mmol/kg) | | element | (s) |
| comparative | 1 | 1.1 | H₂ZrF₆ | 37.0 | Al(OH)₃ | 173.1 | 16.1 | 4.5 | 3.0 | — | — | — | 3 |
| example | 2 | 5.5 | H₂ZrF₆ | 111.1 | Al(OH)₃ | 399.6 | 16.1 | 3.3 | 3.0 | — | — | — | 4 |
| | 3 | 3.3 | H₂ZrF₆ | 37.0 | Al(OH)₃ | 123.4 | 8.1 | 2.8 | 3.0 | — | — | — | 4 |
| | 4 | 11.0 | H₂ZrF₆ | 74.1 | Al(OH)₃ | 532.8 | 48.4 | 6.3 | 3.0 | — | — | — | 3 |
| | 5 | 8.8 | H₂ZrF₆ | 14.8 | Al(NO₃)₃ | 79.4 | 48.4 | 1.8 | 3.0 | — | — | — | 4 |
| | 6 | 11.0 | H₂ZrF₆ | 74.1 | Al(OH)₃ | 532.8 | 44.8 | 6.3 | 3.0 | — | — | — | 3 |

| | | | | base treatment agent, conditions | | | | | |
|---|---|---|---|---|---|---|---|---|---|
| | | surface treatment | | adhesion | | weight | | | |
| | | | adhesion | amount | introduction | average | | | acid |
| | | contact | amount | of | on rate of | molecular | polymer | addition | compounds |
| | | temperature | of Zr | carbon | Z group of | weight of | content | of acid | Content |
| | No | (C.) | (mg/m²) | (mg/m²) | polymer | polymer | (g/L) | compounds | (g/L) |
| comparative | 1 | 55 | 0.5 | — | — | — | — | — | — |
| example | 2 | 55 | 0.5 | — | — | — | — | — | — |
| | 3 | 55 | 6 | — | — | — | — | — | — |
| | 4 | 55 | 0.5 | — | — | — | — | — | — |
| | 5 | 55 | 6 | — | — | — | — | — | — |
| | 6 | 55 | 0.5 | 10 | 0.75 | 10000 | 1.50 | phosphoric acid | 0.48 |

^{※}Shows the weight average molecular weight when x in the formula (I) in the polymer is all hydrogen atoms.

TABLE 2-2

| | test | | | | |
|---|---|---|---|---|---|
| | coating | | | | |
| | dissolution | corrosion test | | laminated film | |
| | resistance | of coating film | | adhesiveness | |
| | aluminum alloy material | | | | |
| | | A5182 | | A3104 | A5812 |
| | | material | | material | material |
| | A5182 | | cut | adhesiveness | adhesiveness |
| | material | blister | width | test1 | test2 |
| comparative | C | C | C | C | C |
| example1 | | | | | |
| comparative | C | C | C | C | C |
| example2 | | | | | |
| comparative | B | C | B | C | C |
| example3 | | | | | |
| comparative | C | C | C | C | C |
| example4 | | | | | |
| comparative | B | C | C | C | C |
| example5 | | | | | |
| comparative | C | — | — | C | C |
| example6 | | | | | |

1. A surface treatment agent to be used for surface treatment of an aluminum alloy material for forming cans, comprising zirconium, aluminum, nitrate radical, and fluorine, wherein
a pH ranges from 2.0 to 4.0,
a molar mass concentration of the zirconium ranges from 3.2 mmol/kg to 33.0 mmol/kg,
a molar mass concentration of the aluminum ranges from 14.8 mmol/kg to 74.1 mmol/kg,
a molar mass concentration of the nitrate radical ranges from 16.1 mmol/kg to 161.4 mmol/kg,
a molar mass concentration of the fluorine ranges from 52.6 mmol/kg to 526.3 mmol/kg, and
(F−6Zr)/Al≥2.5 is satisfied, and substantially no phosphorus compound is contained, and
wherein, F represents the molar mass concentration of the fluorine, Zr represents the molar mass concentration of the zirconium, and Al represents the molar mass concentration of the aluminum.

2. A method for producing an aluminum alloy material for forming cans having a surface-treated coating, comprising a step of contacting the surface treatment agent according to claim 1 on/over a surface of the aluminum alloy material for forming cans.

3. A method for producing an aluminum alloy material for forming cans having a multilayer coating comprising a surface-treated coating and a base coating, comprising:
a step of contacting the surface treatment agent according to claim 1 on/over a surface of the aluminum alloy material for forming cans; and
a step of contacting a base treatment agent comprising a polymer having a repeating structure represented by the following formula (I): 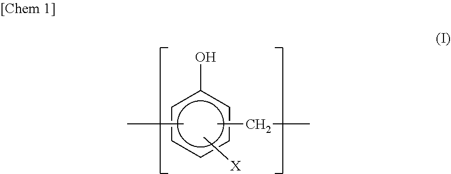
wherein, in formula (I), X is a hydrogen atom or a Z group represented by the following formula (II): 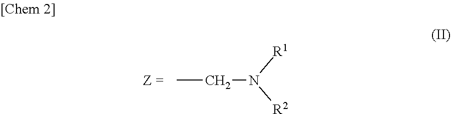
wherein, in formula (II), R¹ and R² are each independently an alkyl group having 10 or less carbon atoms or a hydroxyl alkyl group having 10 or less carbon atoms, and the introduction rate of the Z group ranges from 0.3 to 1.0 per benzene ring,
over the surface of the aluminum alloy material for forming cans with which the surface treatment agent is contacted, wherein
the weight average molecular weight of the polymer ranges from 1,000 to 100,000, when all Xs in the formula (I) are hydrogen atoms.

4. An aluminum alloy material for forming cans having a surface-treated coating, obtained by the production method according to claim 2, wherein an adhesion amount of the surface-treated coating ranges from 1 mg/m² to 50 mg/m² in terms of the mass of a zirconium atom per unit area.

5. An aluminum alloy material for forming cans having a multilayer coating comprising a surface-treated coating and a base coating, obtained by the production method according to claim 3, wherein an adhesion amount of the surface-treated coating ranges from 1 mg/m² to 50 mg/m² in terms of the mass of a zirconium atom per unit area, and
an adhesion amount of the base coating ranges from 0.1 mg/m² to 30 mg/m² in terms of the mass of carbon per unit area.

6. A can lid, comprising a resin composition layer over at least one surface of the aluminum alloy materials for forming cans according to claim 4.

7. A can body, comprising a resin composition layer over at least one surface of the aluminum alloy materials for forming cans according to claim 4.

8. A can lid, comprising a resin composition layer over at least one surface of the aluminum alloy materials for forming cans according to claim 5.

9. A can body, comprising a resin composition layer over at least one surface of the aluminum alloy materials for forming cans according to claim 5.
